(19) United States
(12) Patent Application Publication
(10) Pub. No.: US 2024/0188756 A1
(43) Pub. Date: Jun. 13, 2024

(54) BEVERAGE MAKERS

(71) Applicant: TrendiTech Inc., Burnaby (CA)

(72) Inventors: Rodolfo PIEDRABUENA, Eatons Hill, Queensland (AU); Craig James MCINTOSH, Burnaby (CA); Carissa Nicole CAMPEOTTO, Burnaby (CA)

(73) Assignee: TrendiTech Inc., Burnaby, BC (CA)

(21) Appl. No.: 18/553,051

(22) PCT Filed: Apr. 25, 2022
(86) PCT No.: PCT/IB2022/053828

§ 371 Date: Sep. 28, 2023

Related U.S. Application Data
(60) Provisional application No. 63/182,572, filed on Apr. 30, 2021.

(51) Int. Cl. A47J 31/60; A47J 31/40

(52) U.S. Cl. CPC A47J 31/60; A47J 31/402; A47J 31/404

(57) ABSTRACT

An example of an apparatus to prepare a beverage is provided. The apparatus includes a loading area to receive a container. In addition, the apparatus includes a transport system to move the container to a first location from the loading area. Furthermore, the apparatus includes a powder dispenser to dispense a powder into the container at the first location. The apparatus also includes a liquid dispenser to dispense a liquid into the container. The apparatus additionally includes a mixer to blend the powder and the liquid in the container. Also, the apparatus includes a cleaning system to clean the mixer.

### BACKGROUND

Automated beverage machines are known. For example, vending machines that are capable of dispensing a hot drink such as coffee or hot chocolate are known. Similarly, vending machines may also automatically dispense cold drinks. For example, a vending machine may dispense a beverage or beverage ingredients into a disposable cup placed under a dispenser by a user.

### BRIEF DESCRIPTION OF THE DRAWINGS

Reference will now be made, by way of example only, to the accompanying drawings in which:

FIG. 1A is a schematic representation of an example of an apparatus to prepare a beverage in a first configuration;

FIG. 1B is a schematic representation of an example of the apparatus shown in FIG. 1A to prepare a beverage in a second configuration;

FIG. 1C is a schematic representation of an example of the apparatus shown in FIG. 1A to prepare a beverage in a third configuration;

FIG. 1D is a schematic representation of an example of the apparatus shown in FIG. 1A to prepare a beverage in a fourth configuration;

FIG. 2A is a schematic representation of another example of an apparatus to prepare a beverage in a first configuration;

FIG. 2B is a schematic representation of an example of the apparatus shown in FIG. 2A to prepare a beverage in another configuration;

FIG. 2C is a schematic representation of an example of the apparatus shown in FIG. 2A to prepare a beverage in another configuration;

FIG. 2D is a schematic representation of an example of the apparatus shown in FIG. 1A to prepare a beverage in another configuration;

FIG. 2E is a schematic representation of an example of the apparatus shown in FIG. 1A to prepare a beverage in another configuration;

FIG. 3 is a schematic representation of an example of a powder hopper;

FIG. 4 is a schematic representation of another example of an apparatus to prepare a beverage;

FIG. 5 is a cutaway view of a portion of the apparatus shown in FIG. 4; and

FIG. 6 is flowchart of an example of a method of preparing a beverage.

### DETAILED DESCRIPTION

In describing the components of the device and alternative examples of some of these components, the same reference number may be used for elements that are the same as, or similar to, elements described in other examples. As used herein, any usage of terms that suggest an absolute orientation (e.g. “top”, “bottom”, “front”, “back”, etc.) are for illustrative convenience. Such terms are not to be construed in a limiting sense as it is contemplated that various components will, in practice, be utilized in orientations that are the same as, or different than those described or shown.

An apparatus to automatically provide beverages is provided. In some examples, the apparatus may also include a fee collection system to collect money from a user in exchange for a beverage. The beverage is not particularly limited and may dispense a variety of beverages to hydrate a user.

In some examples, the apparatus may have a hybrid design. In particular, the unit may operate in a self-contained mode where no external connections are installed. Accordingly, this will allow the apparatus to operate in any location where services are not available. In particular, the apparatus may include a water storage system that can keep water at a predetermined temperature, or have portions of the water stored at different temperatures.

During operation, the apparatus may consume water to create a beverage. It is to be appreciated that some water may be discarded or spilled during this process. In some examples, the apparatus may collect the waste water and recirculate it for another purpose to conserve water. The use of the waste water is not particularly limited and may include applications such as for washing fruits or other ingredients, or cleaning components in the apparatus. In another example, the waste water may also be purified or filtered and reintroduced back into the potable water storage system.

In some examples, the apparatus may include a humidity regulation system capable of maintaining a target humidity to preserve ingredients stored within the apparatus. The target humidity is not particularly limited and may be dependent on the ingredients stored in the apparatus. For example, in some applications, a powder may be maintained at about 40% relative humidity to reduce clumping and provide for free flow. In other examples, the target relative humidity may be higher or lower. Furthermore, it is to be appreciated that the water produced by a dehumidifier may be subsequently used by a humidifying element or added to the waste water. Similarly, waste water may be used by a humidifying element to increase the humidity in the apparatus in some applications.

In other examples, the apparatus may provide for connections to electrical and plumbing where such services are available to reduce the amount of servicing of the apparatus. Furthermore, the apparatus may include an ice making feature to generate ice or an ice hopper for use in a beverage in some examples. In these applications, the apparatus may be allowed to independently run for long periods of time without servicing other than to replenish ingredients when they run low.

The beverages provided by the apparatus are not particularly limited. In some examples, multiple ingredients for the beverages are stored in the apparatus in a powder form for dispensing and mixing with water and/or ice. The apparatus may further involve compartments to store water and/or ice in examples without plumbing. In some examples, the apparatus is configured to handle six different ingredients to mix in various combinations to provide enhance water beverages, juices, and or smoothies. Refrigeration systems, heaters, and ice may be used to modify the temperature and viscosity of the beverages. It is to be appreciated that the number of ingredients is not limited to any number and the apparatus may store more than six or fewer than six different ingredients. In addition, the ingredients may be in a form other than powder form, such as solid chunks or liquid. For solid chunks or larger pieces of ingredients, the apparatus may include additional processing devices to process the ingredient, such as to cut, chop, strain, juice, grind, etc.

The apparatus may also be configured to store and provide cups for the beverages. The cups are not particularly limited and may be of varying sizes. For example, a standard size may be 16 oz. However, sizes may be larger or smaller depending on user preference. In some examples, the cups may be reusable and include an identifier for the apparatus to identify the cup and associated user. This may allow the apparatus to offer user preferred recipes. The manner by which the apparatus receives user input is not particularly limited and may involve receiving input via a touchscreen or other input device disposed on the apparatus. In other examples, the input may be received from a terminal connected to the apparatus via a wire or wirelessly. Further examples can include receive input from a user device, such as a smartphone, with an application installed to allowed for input without the user contacting any common surfaces.

In some examples, the apparatus provides a user with an interface to select a drink and recipe. The recipes are not particularly limited and the apparatus may offer a selection of preprogrammed recipes. In addition, the apparatus may allow for the user to design and select customized recipes. The customization is not limited to the selection and quantity of ingredients, but also can be customized based on temperatures and viscosity. In some examples, the temperature and viscosity may be modified with the addition of ice.

The manner by which the ingredients are mixed is not particularly limited. In some examples, the water may be dispensed from a nozzle into a mixing chamber and the powders may be added using a measuring system, such as a scoop or other device. In some examples, the powder may be fed using an Auger screw system, which may also function as an agitator to reduce clumping. The mixing chamber is also not limited and may be a dedicated chamber in the apparatus or it may be the cup in which the beverage is to be served.

It is to be appreciated that beverage provided by the apparatus is not limited. In some examples, the beverages may include enhanced water, juices, and smoothies. Other beverages may include coffee, tea, hot chocolate. Furthermore, beverages may also include baby foods and soup. In further examples, other materials may be dispensed by the apparatus such as animal (pet) food, pharmaceuticals, nutraceuticals, cosmetics and beauty products that are in liquid or paste form.

It is to be appreciated that additional features may also be provided with the apparatus. For example, the apparatus may include a system to wash various components, as well as the reusable cup prior to dispensing a new beverage. The apparatus may also include various indicator lights, or lights for servicing and use. Furthermore, the apparatus may have an optional feature to dispense ice.

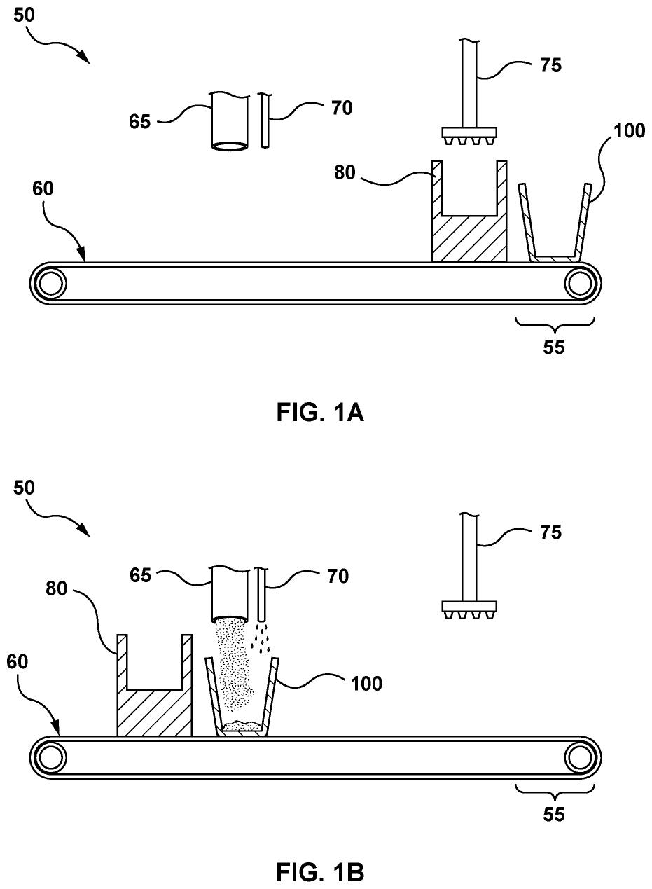

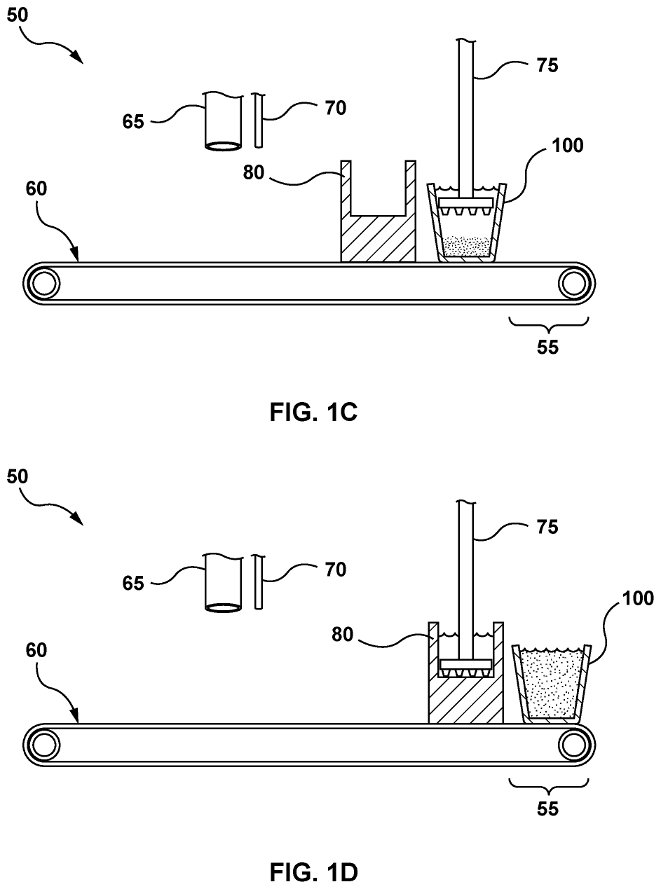

Referring to FIGS. 1A, 1B, 1C, and 1D, a schematic representation of an apparatus to prepare a beverage is generally shown at 50. The apparatus 50 may be part of a larger system to prepare beverages which may include additional peripheral devices, such as sources for ingredients of the beverage as well as additional processing components. In some examples, the apparatus 50 may be part of a broader meal preparation system to provide a beverage as part of the meal or along with food. In the present example, FIG. 1A shows the apparatus 50 in a first configuration for loading and unloading a beverage container 100. FIG. 1B shows the apparatus 50 in a second configuration where ingredients of the beverage are dispensed into the container 100. FIG. 1C shows the apparatus 50 in a third configuration where ingredients of the beverage are mixed while in the container 100. FIG. 1D shows the apparatus 50 in a third configuration where a self-cleaning process may be carried out. The apparatus 50 includes a loading area 55, a transport system 60, a powder dispenser 65, a liquid dispenser 70, a mixer 75, and a cleaning system 80.

The loading area 55 is to receive a container 100. The loading area 55 is not particularly limited and may include any location where a user may place the container 100 for use in the apparatus 50. In the present example, the loading area 55 is a portion of the transport system 60 accessible by the user. Accordingly, once the user places the container 100 in the loading area 55, the apparatus 50 may handle the container 100 to prepare a beverage. In the present example, the container 100 is placed on the transport system 60 and remains in place simply due to the force of friction. Accordingly, the loading area 55 may include a non-slip surface onto which the contain 100 may rest. In other examples, the loading area 55 may include additional mechanisms to secure the container 100. For example, the loading area 55 may include mechanical features such as a recess or a complimentary protrusion or lip to further secure and position the container 100 on the transport system 60. In other examples, the loading area 55 may include further mechanisms such as a clamp or magnet to secure the container 100 to the transport system 60.

In the present example, the container 100 is a reusable cup. However, the container 100 is not particularly limited and may include other types of containers, such as bowls, mugs, reusable bottles, etc. In further examples, the container 100 may also be disposable. In some examples, the apparatus 50 may include a dispenser to dispense the container 100, such as for purchase by a user. Continuing with the present example, the container 100 may then be subsequently used by the user for subsequent purchases from the apparatus 50. It is to be appreciated by a person of skill with the benefit of this description that the style and type of container is not particularly limited. For example, the loading area 55 may be configured to accommodate a wide variety of containers of different shapes and sizes. In other examples, the loading area 55 may be configured to accept a limited number of types of containers that are specifically designed for the apparatus 50. In such examples, the loading area 55 may also include a scanner (not shown) to identify a type of container 100 or the specific container associated with the user. Therefore, the apparatus 50 may reconfigure to accept the container 100 in some examples. In further examples, the apparatus 50 may also scan the container 100 to retrieve a profile or preferred beverage associated with the user of the container 100 where identifying information is provided, such as via a barcode or RFID mechanism.

The transport system 60 is to move the container 100 from the loading area 55 to another location where the beverage is prepared. In the present example, the transport system 60 may be used to return the container 100 to the loading area 55 after the beverage is prepared such that the container 100 with the prepared beverage may be retrieved by the user. It is to be appreciated by a person of skill with the benefit of this description that the transport system 60 may transport the container 100 to multiple locations where different actions are carried out. For example, various ingredients of the beverage may be dispensed into the container 100 at different locations along the transport system 60. Furthermore, various components of the apparatus 50 may interact with other components disposed on the transport system 60 at different locations, such as for cleaning or maintenance of various components of the apparatus 50.

In the present example, the transport system 60 is a conveyor system, such as a conveyor belt to move the container 100 placed thereon. It is to be appreciated by a person of skill with the benefit of this description that the transport system 60 is not particularly limited and may include other systems, such as a moveable platform that engages a track along which the platform may move. Continuing with the present example where the transport system 60 is a conveyor belt, the transport system 60 may receive the container 100 in the loading area 55 as shown in FIG. 1A. Upon receiving the container 100, the transport system 60 may move the container 100 to another location as shown in FIG. 1B where ingredients are to be added to the container 100. The manner by which the apparatus 50 determines that a container 100 is loaded onto the transport system 60 in the loading area 55 is not particularly limited. For example, the user interface, such as a button or touchscreen device, may be used to receive input from a user after the user places the container 100 onto the transport system 60. In other examples, the apparatus 50 may include a sensor in the loading area 55, such as an optical sensor, a weight sensor, or a mechanical sensor to detect when a container 100 is placed on the transport system 60.

In the present example, the powder dispenser 65 is to dispense a powder into the container 100 at the location shown in FIG. 1B. The manner by which the powder dispenser 65 dispenses powder is not particularly limited. For example, a powder transport system may be used to transport the powder from a storage location to the powder dispenser 65. As a particular example, the powder transport system may include a conveyor or auger mechanism to move the powder through a conduit to the powder dispenser 65. In other examples, the powder may be stored above the powder dispenser 65 and a valve may be used to control the dispensing of powder via gravity. In the example where gravity is used to dispense the powder through the powder dispenser 65, an agitator, such as a mechanical or ultrasound agitator, may be used to reduce blockages along the path caused by a clog in the conduit.

The powder dispensed by the powder dispenser 65 is not particularly limited. In some examples, the powder may be a flavored crystal to dissolve with a liquid such as water to form a drink. In other examples, the powder may be a dried food product, such as from a freeze drying process, to add nutrients and flavor to the beverage.

It is to be appreciated by a person of skill with the benefit of this description that the powder dispenser 65 may dispense more than one type of powder into the container 100. For example, multiple conduits may deliver different powders to the powder dispenser 65 where each conduit is controlled with a valve or other mechanism. The amount and type of powder being dispensed via the powder dispenser 65 may be manually controlled by manipulating the valves in some examples. In other examples, the valves may be electronically controlled based on user input to the apparatus 50, such as via a user interface device or a mobile device via an app. Accordingly, different powders may be added in different quantities to prepare a customized beverage with a taste based on selections from the user. Although the present example illustrates a single powder dispenser 65, other examples may include additional powder dispensers where each powder dispenser may dispense a different powder or a different group of powders.

The liquid dispenser 70 is to dispense a liquid into the container 100 as shown in FIG. 1B. In the present example, since both the powder and the liquid are dispensed with the container 100 at the same location, the powder and the liquid may be dispensed simultaneously via the powder dispenser 65 and the liquid dispenser 70 operating independently. By dispensing the powder and liquid into the container 100 simultaneously, mixing is promoted between these ingredients of the beverage. In other examples, the liquid may be dispensed after the powder is dispensed or vice versa.

The liquid dispensed by the liquid dispenser 70 is not particularly limited. In the present example, the liquid is water and may be received from a building water source. In other examples, the liquid may be a flavored mixture or solution to be used as a base for preparing beverages. Furthermore, in some examples, the liquid dispensed from the liquid dispenser 70 may be stored in a reservoir disposed within the apparatus 50. Accordingly, the apparatus 50 may be place in any location regardless of whether there is a pre-existing source. Such an example may also be portable such that it may be moved between different locations.

It is to be appreciated by a person of skill with the benefit of this description that the liquid dispenser 70 may dispense more than one type of liquid into the container 100. For example, multiple conduits may deliver different liquids to the liquid dispenser 70 where each conduit is controlled with a valve or other mechanism. The amount and type of liquid being dispensed via the liquid dispenser 70 may be manually controlled by manipulating the valves in some examples. In other examples, the valves may be electronically controlled based on user input to the apparatus 50, such as via a user interface device or a mobile device via an app. Accordingly, different liquids may be added in different quantities to prepare a customized beverage with a taste based on selections from the user. Although the present example illustrates a single liquid dispenser 70, other examples may include additional liquid dispensers where each liquid dispenser may dispense a different liquid or a different group of liquids.

In the present example, the mixer 75 is to blend the powder dispensed by the powder dispenser 65 and the liquid dispensed by the liquid dispenser 70. The mixer 75 blends the powder and the liquid in the container 100 at the location shown in FIG. 1C. By using the container 100 as the mixing vessel, the number of parts used to prepare the drink is reduced which may increase the reliability of the apparatus 50 as well reduces the number of parts to clean between uses. The manner by which the mixer 75 blends the powder and liquid is not particularly limited and may be varied depending on the ingredients of the beverage. For example, the mixer 75 may be rotated within the container 100 to agitate the powder and liquid. In the present example, the mixer 75 may include blades or fins to increase the amount of agitation during rotation. In other examples, the mixer 75 may oscillate regularly or irregularly to blend the powder and liquid. The mixer 75 may also move vertically to agitate the liquid. In further examples, the mixer 75 may also move laterally within the container 100.

It is to be appreciated by a person of skill with the benefit of this description that the design of the mixer 75 is not particularly limited. The mixer 75 is to be able to mechanically rigid enough to blend the powder and liquid in the container. Accordingly, the mixer 75 is to be made from a rigid material that is capable of withstanding forces associated with the rotation speed of the mixer 75 in a mixture within a viscosity range. The mixer 75 may be made from several components connected together in some examples or it may be made from a unitary design. The materials from which the mixer 75 is constructed is not particularly limited. In the present example, the mixer 75 is made from stainless steel. In other examples, the mixer 75 may be made from plastic.

Furthermore, the shape of the mixer 75 is not particularly limited and may include features such as fins, blades, or other shapes disposed at an end or along the length of the mixer 75. The shape and size of such features may vary depending on the application. For example, steel blades may be used to break ice if that is an ingredient in of the beverage. Round mixing fins may be using for applications where gentle mixing is to be used. It is to be appreciated by a person of skill with the benefit of this description that the mixer 75 may interchangeable to allow for different mixing mechanisms for different beverages. In other example, examples, the apparatus may include multiple mixers at different locations such that the transport system 60 can move the container 100 to the appropriate mixer.

The cleaning system 80 is to clean the mixer 75 after the beverage is prepared. The cleaning system 80 is not particularly limited and may include any system or device that is configured to remove residual beverage that may remain on portions of the mixer 75 after the mixer 75 has blended the ingredients. In the present example, the cleaning system 80 is a bowl to receive a liquid, such as water or a cleaning solution, into which the mixer 75 is lowered. The liquid may be provided to the cleaning system 80 via the liquid dispenser 70 is some examples or with a separate liquid dispenser (not shown). The mixer 75 may be cleaned with a rotating motion while submerged in the cleaning system 80. In some examples, the cleaning system 80 may include additional agitators to facilitate removal of material from the mixer 75. For example, the cleaning system may include an ultrasonic cleaner, jets, or brushes. The liquid in the cleaning system 80 is not limited and may be water dispensed via the liquid dispenser 70. Alternatively, additional dispensers may be used to dispense the liquid for the cleaning system 80. It is to be appreciated by a person of skill in the art with the benefit of this description that the cleaning system 80 may also include a drain or other means to remove the liquid. The liquid may be removed after each time the mixer 75 is cleaned or after a number of uses to conserve the liquid.

The configuration at which the cleaning system 80 cleans the mixer 75 is not particularly limited and the transport system 60 may be used to move the cleaning system 80 to the mixer 75. In the present example, the cleaning system 80 cleans the mixer 75 at the location shown in FIG. 1D. It is to be appreciated by a person of skill with the benefit of this description that the configuration shown in FIG. 1D is the same configuration as shown in FIG. 1A where the container 100 is returned to the loading area 55 where the user may retrieve the container 100 with the beverage therein. Furthermore, by positioning the cleaning system 80 as shown in FIGS. 1A to 1D, the cleaning system 80 may be cleaning the mixer 75 at the same time the user removes the container 100 from the loading area 55. Accordingly, the user retrieves the beverage sooner without waiting for the cleaning process to be completed.

It is to be appreciated that variations to the apparatus 50 are contemplated. For example, the various components in the apparatus 50 may be further spaced out such that the transport system 60 is to move the container 100 to more locations. Furthermore, additional dispensers may also be included to provide more variation in the number of ingredients available for the beverage. Furthermore, another variation may involve moving the various dispensers and systems to the container 100 instead of moving the container 100.

It is to be appreciated by a person of skill with the benefit of this description that variations to the apparatus 50 are possible. Further variations may include a design with sufficient weatherproofing such that it may be operated outdoors in the elements in harsh environments. For outdoor use, the apparatus may also be equipped with alternative energy sources to allow for operation without a fixed electrical source nearby. In this example the apparatus may include a battery to power the apparatus as well as a solar panel or wind generator to recharge the battery.

As another example of a variation, it is to be appreciated that the apparatus 50 may include a processor to control the various components of the apparatus 50. For example, the processor may be used to control the transport system 60 to move the container between the various locations. Similarly, the processor may include instructions to control the powder dispenser 65 and the liquid dispenser 70. The operation of the mixer 75, such as the rotation speed, or the lowering and raising of the mixer 75 in to the container 100 may be controlled by a processor. In further examples, the processor may also be connected to a network, such as a wireless network or cellular network to communicate with a central server. In such an example, the central server may provide instructions to the apparatus 50, such as updates to the control software or providing additional recipes for beverages. In addition, the central server may retrieve data from the operating device to measure the performance of the apparatus 50 or to obtainer sales data.

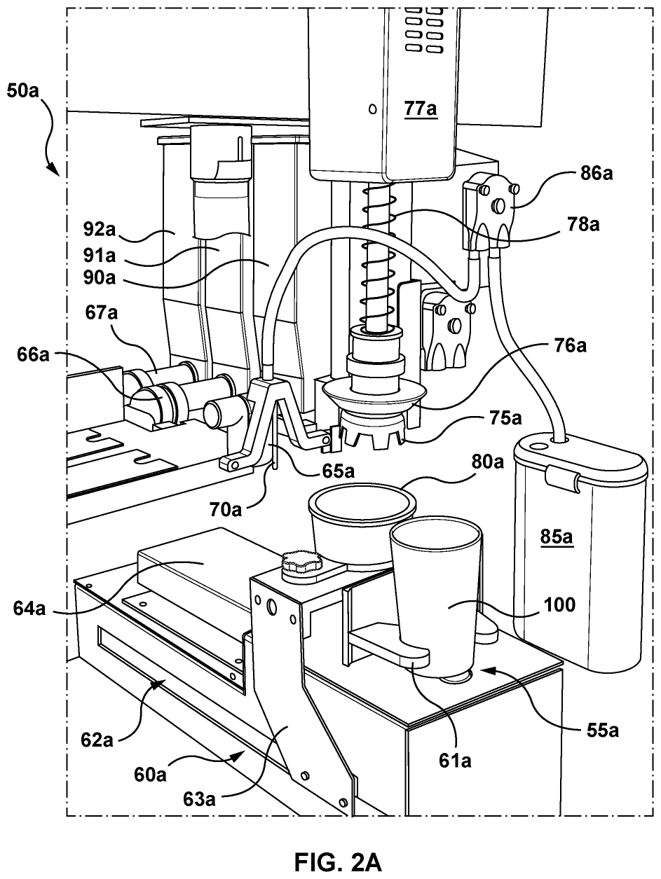

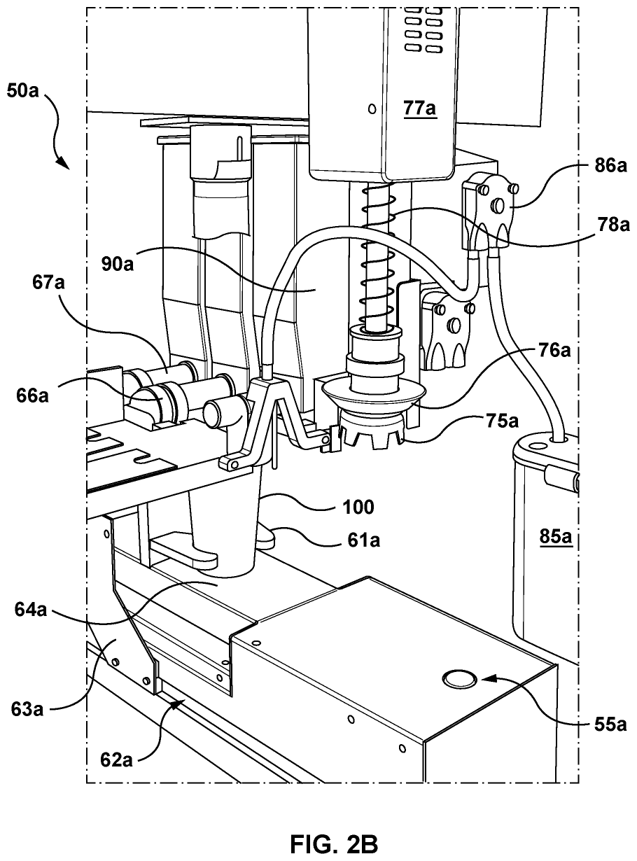

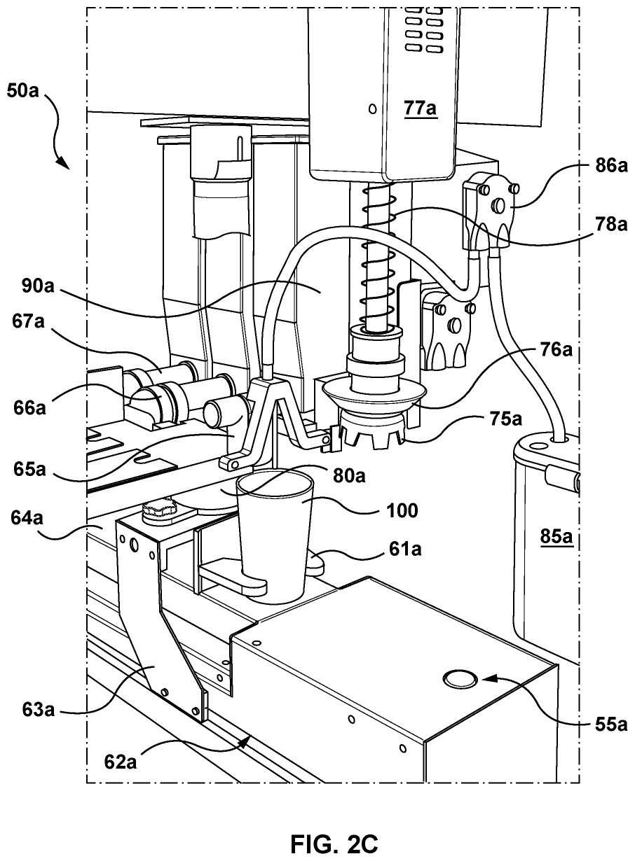

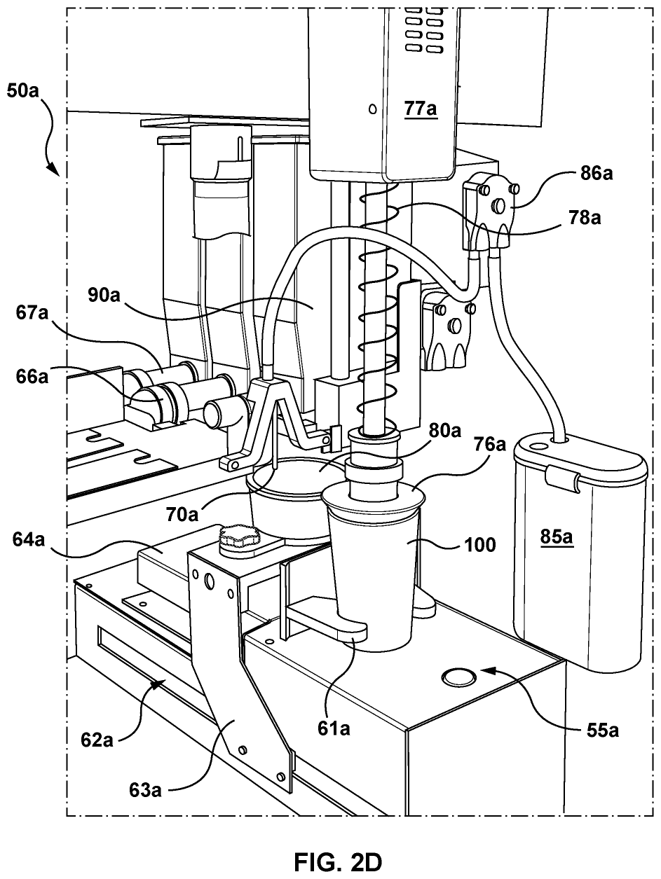

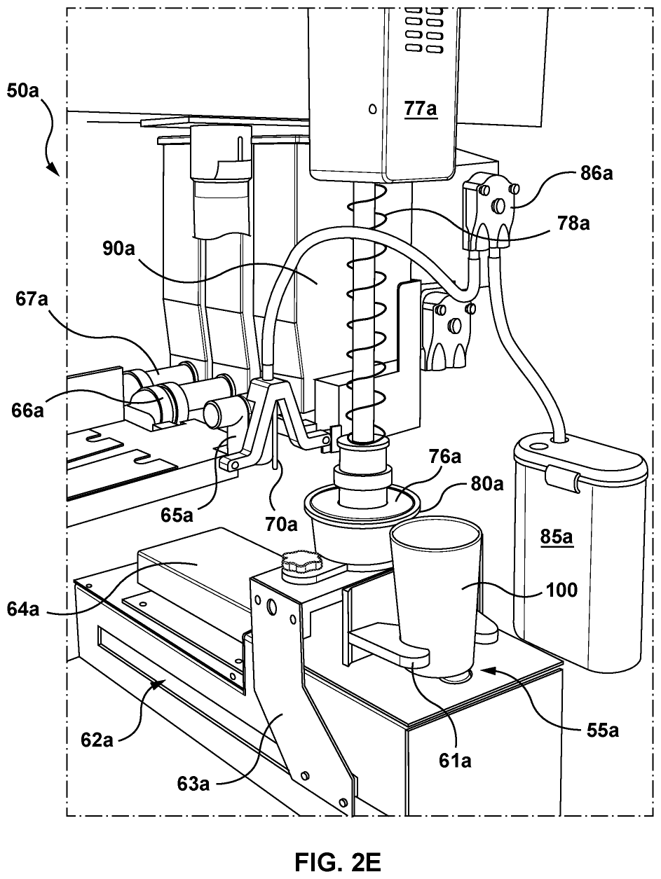

Referring to FIGS. 2A, 2B, 2C, 2D, and 2E, a schematic representation of another apparatus 50a to prepare a beverage is generally shown. Like components of the apparatus 50a bear like reference to their counterparts in the apparatus 50, except followed by the suffix “a”. In the present example, FIG. 2A shows the apparatus 50a in a first configuration for loading and unloading the beverage container 100. FIG. 2B shows the apparatus 50a in a second configuration where a powder is dispensed into the container 100. FIG. 2C shows the apparatus 50a in another configuration where a liquid is dispensed into the container 100. FIG. 2D shows the apparatus 50a in another configuration where ingredients of the beverage are mixed in the container 100. FIG. 2E shows the apparatus 50a in a third configuration where a self-cleaning process may be carried out. The apparatus 50a includes a loading area 55a, a transport system 60a, a powder dispenser 65a, a liquid dispenser 70a, a mixer 75a, a cleaning system 80a, a liquid reservoir 85a, and a plurality of powder hoppers 90a, 91a, 92a.

The loading area 55a is to receive a container 100. In the present example, the loading area 55a is a substantially horizontal surface accessible by the user. Accordingly, once the user places the container 100 on the loading area 55a, a holder 61a may be used to secure the container 100 to the transport system 60a as discussed in further detail below.

In the present example, the transport system 60a is to move the container 100 to various locations during the beverage preparation process. In the present example, the transport system 60a includes a holder 61a to secure the container 100 to a moveable gantry 63a which may be moved along a track 62a. The holder 61a is mounted onto the gantry 63a such that movement of the gantry 63a will move the container 100 that is secured by the holder 61a. Therefore, the holder 61a effectively slides along the track 62a to move the container 100 from the loading area 55a to one or more other locations as the beverage is being prepared by the apparatus 50a.

The holder 61a is not particularly limited and it is to be appreciated by a person of skill with the benefit of this description that various mechanisms and materials may be used to secure the container 100 during movement by the transport system. In the present example, the holder 61a includes a pair of rigid arms configured to allow the container 100 to fit within a substantially circular opening. The container 100 may also be tapered to allow the container 100 to rest in the opening when the outer diameter is substantially equal to the diameter of the opening. In other examples, the holder 61a may include arms that can pivot to accommodate a larger range of container sizes. In such examples, the arms of the holder 61a may include a biasing mechanism to clamp the container 100. In further examples, the holder 61a may be made of a resiliently deformable material such as rubber to secure the container 100 by stretching and applying a friction fit as the user inserts the container 100 into the holder 61a.

The manner by which the holder 61a is mounted to the gantry 63a is not particularly limited. In the present example, the holder 61a is secured to the gantry 63a using fasteners, such as bolts. In other examples, the holder 61a may be welded to the gantry 63a or be part of the same unitary body.

The gantry 63a is slidably engaged to the track 62a. In the present example, the track 62a is a slot into which the gantry 63a is mounted. For example, the gantry 63a may include wheels to engage with the bottom portion of the track 62a to allow for movement along the track 62a. In this example, the wheels may be coupled to a motor to drive the gantry 63a along the track 62a. In other examples, the wheels may simply provide a reduced friction engagement and the gantry 63a may be moved via another drive mechanism to move the gantry 63a along the track 62a. In these examples, it is to be appreciated by a person of skill with the benefit of this description that the gantry 63a may engage the track 62a with a mating protrusion having a low coefficient of friction to allow the gantry 63a to slide along the track 62a in examples where the driving mechanism is provided to the gantry elsewhere.

In the present example, a scale 64a may be disposed on the transport system 60a to measure a weight of the contents in the container 100. It is to be appreciated by a person of skill with the benefit of this description that that the scale 64a may be used to control the amount of each ingredient dispensed into the container 100.

Furthermore, variations to the transport system 60a are contemplated. For example, the holder 61a may engage directly with the track 62a without a gantry 63a in some examples where an arm may have sufficient mechanical rigidity to support the holder 61a and the container 100 with its contents. Furthermore, in the present examples, the holder 61a suspends the container 100 above the surface in the loading area 55a. In other examples, the holder 61a may drag the container 100a along the surface to various locations such that the holder 61a does not support the entire weight of the container 100 and its contents.

In the present example, the transport system 60a moves the container 100 to the powder dispenser 65a, which is used to dispense a powder into the container 100 at the location shown in FIG. 2B. The manner by which the powder dispenser 65a dispenses powder is not particularly limited and may include mechanism discussed above in connection with the powder dispenser 65. After the container 100 receives a designated amount of powder based on a recipe, the transport system 60a moves the container 100 to the location shown in FIG. 2C, such that the container 100 is located under the liquid dispenser 70a. It is to be appreciated by a person of skill with the benefit of this description that the location of the container 100 to receive the liquid from the liquid dispense 70a is different from the location where the container 100 receives powder from the powder dispenser 65a. By separating the powder dispenser 65a and the liquid dispenser 70a, the contamination of powder at the liquid dispenser 70a, which may result in clogs and reduced performance, is reduced. Similarly, the contamination of liquid at the powder dispenser 65a, which may result in clumping of the powder and reduced performance, is reduced. In addition, by providing more distance between the components within the apparatus 50a, servicing of the apparatus 50a is facilitated.

The apparatus 50a further includes powder dispenser 66a and powder dispenser 67a. The powder dispenser 66a and the powder dispenser 67a are configured to dispense different powders to the container 100 from the powder hopper 91a and the powder hopper 92a, respectively. In the present example, the powder dispenser 66a and the powder dispenser 67a are each located at different locations to which the transport system 60a may move the container 100 to receive powders from the powder dispenser 66a and the powder dispenser 67a. In other examples, the powder dispenser 66a and the powder dispenser 67a may be disposed closer to the powder dispenser 65a such that they may all dispense powder into the container 100 at the same location. Furthermore, although the present example shows three powder dispensers, it is to be appreciated by a person of skill with the benefit of this description that more or fewer powder dispensers may be deployed in the apparatus 50a depending on the number of ingredients that are to be made available to a user.

In the present example, the liquid dispensed by the liquid dispenser 70a is stored in the liquid reservoir 85a and moved to the liquid dispenser 70a via the pump 86a. In the present example, the liquid stored in the liquid reservoir 85a is water. In other examples, the liquid may be a flavored mixture or solution to be used as a base for preparing beverages. It is to be appreciated that the liquid reservoir 85a provides a self-contained unit that can operate in locations where no water sources are available. Accordingly, the apparatus 50a may be installed in any location and moved between locations relatively easily. The size of the reservoir 85a is not particularly limited and may have various capacities depending on the application, such as the availability of being refilled periodically. Furthermore, in some examples, there may be multiple liquid reservoirs to dispense different liquids for the preparation of the beverage.

The pump 86a is not particularly limited and configured to move liquid from the liquid reservoir 85a to the liquid dispenser 70a. The pump 86a may include a mass flow meter to measure the amount of liquid moved from the reservoir 85a to the liquid dispenser 70a where it is dispensed. Accordingly, the pump 86a may be used to provide a target amount of liquid in accordance with the recipe of the beverage.

In the present example, the mixer 75a is to blend the powder dispensed by the powder dispenser 65a and the liquid dispensed by the liquid dispenser 70a into the container 100. In the present example, the mixer 75a includes a rubber seal 76a to cover the opening of the container 100. By covering the opening of the container 100, spillage of the contents of the container 100 during the blending process as shown in FIG. 2D. The rubber seal 76a may mate with the opening of the container 100 to form a waterproof seal in some examples as the mixer 75a is lowered over the opening. In some examples, the rubber seal 76a may be spring loaded with a spring 78a to apply force to form the waterproof seal. In other examples, the rubber seal 76a may include a negative pressure port (not shown) to provide suction to assist with the formation of a vacuum seal about the opening of the container 100. It is to be appreciated that in some examples, the rubber seal 76a may be replaced with a seal of another material, such as silicone. In further examples, the rubber seal 76a may also be substituted with a rigid cover or splash guard.

In the present example, the mixer 75a is operated with a control unit 77a which may include a motor to rotate or actuate the mixer 75a. The manner by which the mixer 75a blends the powder and liquid is not particularly limited and may be varied depending on the ingredients of the beverage. For example, the mixer 75a may be rotated by the control unit 77a to agitate the powder and liquid within the container 100. The mixer 75a may include blades or fins to increase the amount of agitation during rotation. In other examples, the mixer 75a may be actuated up and down to oscillate regularly or irregularly to blend the powder and liquid. In further examples, the control unit 77a may also move the mixer 75a laterally within the container 100.

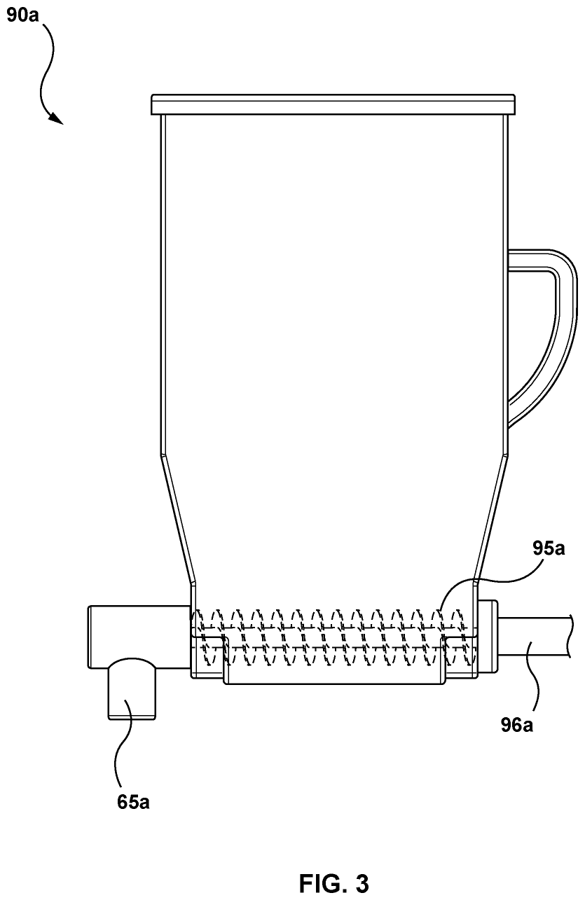

Referring to FIG. 3, a more detailed view of the powder hopper 90a is shown. The hopper 90a is to be installed in the apparatus 50 as shown in FIGS. 2A to 2E. The hopper 90a is to store the powder to be used as an ingredient in the beverage to be prepared. In particular, the hopper 90a is to provide the powder to the powder dispenser 65a. The manner by which the powder is moved from the hopper 90a to the powder dispenser 65a is not particularly limited. In the present example, the hopper 90a includes an auger conveyor 95a to move the powder to the powder dispenser 65a for dispensing into the container 100. The auger conveyor 95a may be rotated with an external drive shaft 96a via a motor in the apparatus 50a (not shown).

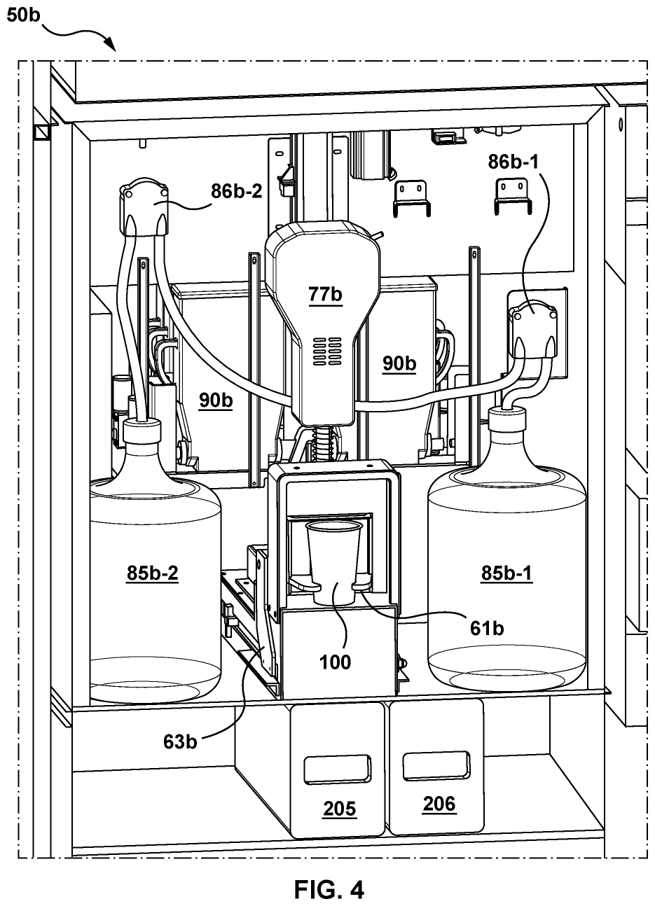

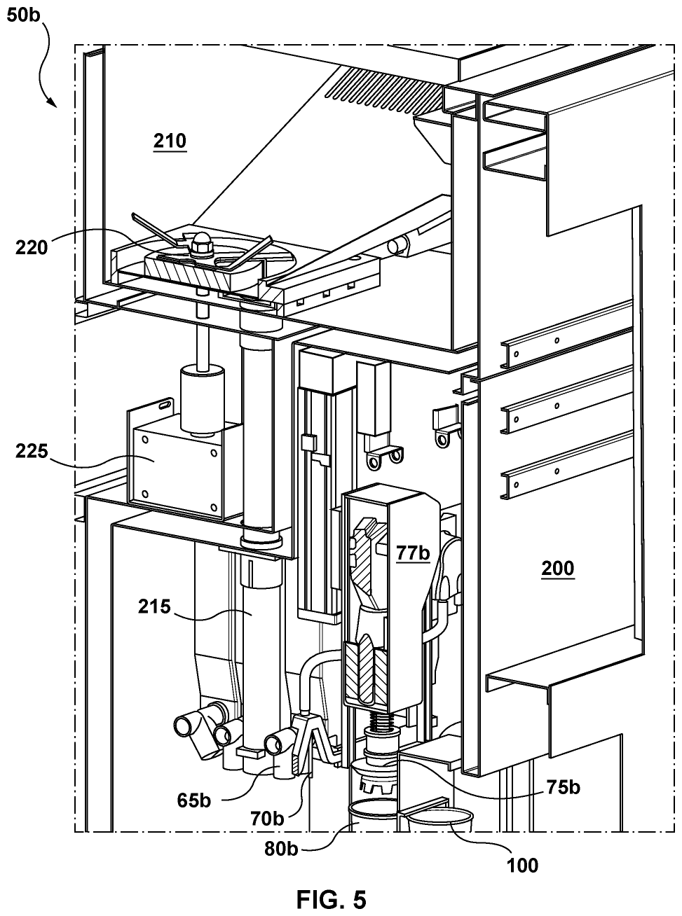

Referring to FIGS. 4 and 5, representations of another apparatus 50b to prepare a beverage are generally shown. Like components of the apparatus 50b bear like reference to their counterparts in the apparatus 50a, except followed by the suffix “b”. In the present example, FIG. 4 shows the internal components of the apparatus 50b with the front cover 200 removed. FIG. 5 is a cutaway view of the apparatus 50b. The apparatus 50b includes a loading area 55b, a transport system 60b, a powder dispenser 65b, a liquid dispenser 70b, a mixer 75b, a cleaning system 80b, liquid reservoirs 85b-1 and 80b-2 (generically, these liquid reservoirs are referred to herein as “liquid reservoir 85b” and collectively they are referred to as “liquid reservoirs 85b”), and a plurality of powder hoppers 90b. In addition, the apparatus 50b includes an ice dispenser 215 and collection containers 205 and 206.

In the present example, the mixer 75b is operated with a control unit 77b which may include a motor to rotate or actuate the mixer 75b. In the present example, the ice dispenser 215 may add ice in the form of cubes or chunks into the container. The manner by which the mixer 75b blends the ice, powder, and liquid is not particularly limited and may be varied depending on the ingredients of the beverage. For example, the mixer 75b may be rotated by the control unit 77b to agitate the powder and liquid within the container 100. The mixer 75b may include blades to break the ice during rotation to form a slush. In other examples, the mixer 75b may be actuated up and down to oscillate regularly or irregularly to blend the powder and liquid. In further examples, the control unit 77b may also move the mixer 75b laterally within the container 100.

In the present example, the liquid dispensed by the liquid dispenser 70b is stored in the liquid reservoirs 85b-1 and 85b-2 moved to the liquid dispenser 70b via the pumps 86b-1 and 86b-2, respectively. In other examples, a single pump may be used to move liquid from the liquid reservoirs 85b-1 and 85b-2 to the liquid dispenser 70b. In the present example, the liquid stored in the liquid reservoirs 85b may be different. In an example, the liquid reservoir 85b-1 may be used to store water or another liquid for use in the preparation of the beverage. In this example, the liquid reservoir 85b-1 may be used to store a cleaning solution to be used with the cleaning system 80b to clean the mixer 75b after the preparation of the beverage. In other examples, each of the liquid reservoirs 85b may contain different flavors for the preparation of beverages.

The apparatus 50b further includes collection containers 205 and 206 to collect waste water. During the preparation of a beverage, it is to be appreciated by a person of skill with the benefit of this description that the beverage preparation process may produce waste liquid and powders. For example, liquid and powder may splash out of the container 100 during dispensing or may overflow. In addition, the liquid used to clean the mixer 75b may be drained after each cleaning or periodically to be replaced with fresh liquid. Accordingly, drains may be disposed in the apparatus to collect any waste liquid into the collection containers 205 and 206. In the present example, the collection containers 205 and 206 may collect different waste. For example, the collection container 205 may collect waste water from the preparation of the beverage and the collection container 206 may collect waste water from the cleaning system. In some examples, the waste water in the collection containers 205 and 206 may be recycled for subsequent use as either cleaning liquid or for the preparation of beverages to reduce waste. The recycling of the waste water is not particularly limited and may include passing the water through a purification system or filters to remove any contaminants or substances not suitable for the preparation of a beverage. In further examples, the collection containers 205 and 206 may be used for the cleaning system where a container 205 may be used to provide, via pump (not shown), washing liquid and the container 206 may be used to collect waste washing liquid.

It is to be appreciated that the collection containers 205 and 206 may provide a self-contained unit that can operate in locations where waste water cannot be discarded outside the machine. For example, the apparatus 50b may be installed in room where no drain is readily available. Accordingly, expelling waste liquid onto the floor of the room is inappropriate. The size of the collection containers 205 and 206 are not particularly limited and may have various capacities depending on the application, such as the availability of being emptied periodically.

FIG. 5 is a cutaway view of the apparatus 50b to show an upper portion. In the present example, the apparatus 50b further includes an ice hopper 210 to provide ice to the ice dispenser 215 which in turn is to add ice to the container 100 during the preparation of the beverage. The ice hopper 210 is not particularly limited and may include a refrigeration system (not shown) to keep the ice within the hopper 210 cold. In other examples, the ice hopper 210 may be insulated to maintain the ice which may slowly melt over time. Further examples may also include an ice maker to add ice to the ice hopper 210 as ice is released through the ice dispenser 215 or melts over time. The ice maker may use water from the reservoirs 85b or from an external water source.

In the present example, the apparatus 50b further include an agitator 220 to mix the ice so that the ice can fall into the ice dispenser 215. The agitator 220 may be rotated with a motor 225 when ice is to be dispensed into the container 100. When the agitator 220 is not moving, the ice may jam in the hopper 210 and does not fall down into other portions of the apparatus 50b.

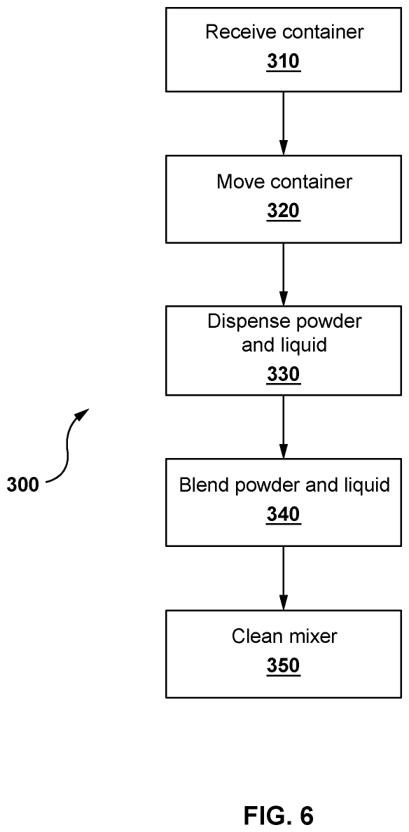

Referring to FIG. 6 a flowchart of a method of preparing a beverage is generally shown at 300. In order to assist in the explanation of method 300, it will be assumed that method 300 may be performed with the apparatus 50, 50a or 50b. Indeed, the method 300 may be one way in which the apparatus 50, 50a or 50b may be used. Furthermore, the following discussion of method 300 may lead to a further understanding of the apparatus 50, 50a or 50b as well as their components. In addition, it is to be emphasized, that method 300 may not be performed in the exact sequence as shown, and various blocks may be performed in parallel rather than in sequence, or in a different sequence altogether. For the purposes of the discussion below, it is to be assumed that the method 300 is to be carried out by the apparatus 50.

Beginning at block 310, the apparatus 50 is to receive a container 100 in the loading area 55. The manner by which the container 100 is received at the loading area 55 is not particularly limited. In the present example, a user is to place the container 100 in the loading area 55. The container 100 may then be secured to the transport system 60, which may involve a securing mechanism or simply the force of friction between the container and a portion of the transport system 60, such as a horizontal surface of a conveyor belt.

Next, block 320 moves the container 100 from the loading area 55 to other portions of the apparatus, such as the powder dispenser 65 and the liquid dispenser 70. The manner by which the container 100 is moved is not particularly limited. For example, the container 100 may be moved along the surface of a conveyor belt in some examples such as those described above in connection with the transport system 60. In other examples, the container 100 may be secured to the transport system 60a which slides along a track to different locations of the apparatus 50.

At the one or more locations to which the container 100 is moved by the transport system 60, powder and liquid may be dispensed into the container via the powder dispenser 65 and the liquid dispenser 70, respectively, at block 330. The source of the powder and the liquid dispensed is not particularly limited. In some examples, the powder may be stored in a hopper and fed toward the powder dispenser via an auger conveyor. The liquid may be stored in a reservoir and pumped to the liquid dispenser 70.

It is to be appreciated by a person of skill that additional powders and liquids may be added to be beverage, such as powders and liquids of different flavors to achieve a specified taste based on a recipe. Accordingly, the apparatus 50 may include multiple hoppers of powder where the amount of each powder added to the container 100 is controlled to achieve a target flavor.

Furthermore, in some examples, the apparatus 50 may include an ice dispenser to add ice to the container 100 during the preparation of the beverage. For some beverages, the ice may be added at the end of the preparation process such that ice cubes or chunks are preserved in the container. In other examples, the ice may be crushed or broken into finer pieces with the blade of the mixer 75.

Once all the ingredients are in the container, the mixer 75 is to blend the contents of the container at block 340. The manner by which the contents are blended is not particularly limited. For example, the mixer 75 may simply agitate the contents of the container 100. Since the blending process may splash some contents out of the container 100, some examples may cover the opening of the container with a lid to reduce splashing. For example, the lid may be a plastic cover. In other examples, a rubber seal may be used to cover the opening of the container to further reduce splashing. In some examples, the rubber seal may form a vacuum seal to completely container the contents of the container 100.

After the beverage is prepared, the mixer 75 is then cleaned at block 350 with the cleaning system 80 to remove residual beverage that may remain on portions of the mixer 75 after the mixer 75 has blended the ingredients. In the present example, the mixer 75 may be cleaned with a rotating motion while submerged in the cleaning system 80. In other examples, the cleaning system 80 may include additional agitators to facilitate removal of material from the mixer 75 such as an ultrasonic cleaner, jets, or brushes. The liquid in the cleaning system 80 is not limited and may be water dispensed via the liquid dispenser 70. Alternatively, additional dispensers may be used to dispense the liquid for the cleaning system 80. It is to be appreciated by a person of skill in the art with the benefit of this description that the cleaning system 80 may also include a drain or other means to remove the liquid. The liquid may be removed after each time the mixer 75 is cleaned or after a number of uses to conserve the liquid.

It should be recognized that features and aspects of the various examples provided above may be combined into further examples that also fall within the scope of the present disclosure.

1. An apparatus comprising:
a loading area to receive a container;
a transport system to move the container to a first location from the loading area;
a powder dispenser to dispense a powder into the container at the first location;
a liquid dispenser to dispense a liquid into the container;
a mixer to blend the powder and the liquid in the container; and
a cleaning system to clean the mixer.

2. The apparatus of claim 1, further comprising an ice dispenser to add ice to the container.

3. The apparatus of claim 2, wherein the mixer includes a blade to break the ice in the container.

4. The apparatus of claim 1, wherein the transport system includes a holder to secure the container.

5. The apparatus of claim 4, wherein the holder slides along a track to move the container to the first location from the loading area.

6. The apparatus of claim 1, further comprising a hopper to store the powder and an auger conveyor to move the powder from the hopper to the powder dispenser.

7. The apparatus of claim 1, wherein the liquid dispenser dispenses the liquid at a second location, and wherein the transport system is to move the container from the first location to the second location.

8. The apparatus of claim 1, wherein the mixer includes a rubber seal to cover an opening of the container.

9. The apparatus of claim 8, wherein the rubber seal is to form a vacuum seal at the opening of the container.

10. A method comprising:
receiving a container at a loading area;
moving the container to a first location from the loading area;
dispensing a powder into the container at the first location;
dispensing a liquid into the container;
blending the powder and the liquid in the container with a mixer; and
cleaning the mixer with a cleaning system.

11. The method of claim 10, further comprising adding ice to the container.

12. The method of claim 11, wherein breaking the ice in the container with a blade of the mixer.

13. The method of claim 10, further comprising securing the container to a transport system.

14. The method of claim 13, further comprising sliding a holder of the transport system along a track to move the container to the first location from the loading area.

15. The method of claim 10, further comprising storing the powder in a hopper.

16. The method of claim 14, wherein dispensing the powder comprises moving the powder from the hopper to the container with an auger conveyor.

17. The method of claim 10, wherein dispensing the liquid comprises moving the container from the first location to a second location and dispensing the liquid at the second location.

18. The method of claim 10, further comprising covering an opening of the container with a rubber seal.

19. The method of claim 18, wherein covering the opening forms a vacuum seal at the opening of the container.
